(19) United States
(12) Patent Application Publication
(10) Pub. No.: US 2004/0143609 A1
(43) Pub. Date: Jul. 22, 2004

(54) System and method for data extraction in a non-native environment

(76) Inventors: Daniel John Gardner, St. Louis Park, MN (US); Mark Anthony Seel, Roseville, MN (US)

Correspondence Address: GRAY, CARY, WARE & FREIDENRICH LLP, 1221 SOUTH MOPAC EXPRESSWAY, SUITE 400, AUSTIN, TX, 78746-6875, US

(21) Appl. No.: 10/697,728

(22) Filed: Oct. 30, 2003

Related U.S. Application Data
(60) Provisional application No. 60/440,855, filed on Jan. 17, 2003.
(60) Provisional application No. 60/440,728, filed on Jan. 17, 2003.

(51) Int. Cl. G06F 7/00

(52) U.S. Cl. 707/204

(57) ABSTRACT

A method and system can be used to read and obtain data from backup media regardless of the application used to generate the backup media. The method and system can read part of a tape to identify the application used to generate a backup tape and access information on where information is located on the tape based on an identifying signature. The method and system can be used to process large amounts of data from backup tapes without having to recreate the native backup environment. Filters may be applied to determine which data is relevant and storing that information on a target sub-system that may have a different operating system compared to the computer from which the backup tape was generated. The method and system are particularly useful for identifying and segregating evidence or for performing knowledge management functions at a company, potentially having over a thousand employees.

### RELATED APPLICATIONS

This application claims priority under 35 U.S.C. § 119(e) to U.S. patent application Nos. 60/440,855 entitled “System and Method for Data Extraction in a Non-Native Environment, Data De-Duplication, Database Creation and Manipulation, Image Back-up and PST File Monitoring” by Gardner et al. filed Jan. 17, 2003, and 60/440,728 entitled “System and Method for Data Extraction in a Non-Native Environment, Data De-Duplication, Database Creation and Manipulation, Image Back-up and PST File Monitoring” by Gomes et al. filed Jan. 17, 2003, both of which are assigned to the current assignee hereof and incorporated herein by reference.

### FIELD OF THE INVENTION

This invention is related to obtaining of data from backup media, and more particularly, to methods and systems to obtain data from backup media in order to determine metadata and contents of files and directories.

### DESCRIPTION OF THE RELATED ART

Vast amounts of active and archived corporate electronic information exist on backup tape media. This information is increasingly becoming the target of opposing litigation attorneys or increasingly important as a source of information for knowledge management. Conventional methods of producing data from large quantities of backup tapes are difficult to implement, cost prohibitive, or both.

A problem with managing data from backup media is particularly problematic with companies having many different tape backup systems using different backup environments. A previous attempt to solve the problem of retrieving information from backup tapes involves restoring the tapes using a “Native Environment” (NE) approach. The NE approach recreates the original backup environment from which the tape was generated so that data from the tapes can be restored and moving the restored data from the replicated environment to a target storage system for further analysis.

Replicating the NE in order to restore backup tapes requires that all server names, configurations, software versions, user names, and passwords are consistent with the environment as it stood at the time of the backup. Replicating all of this information becomes quite challenging as systems age, names of systems change, passwords change, software versions change, and administrators change. Furthermore, backup software is typically designed to restore data for the purposes of disaster recovery (an all or nothing proposition) and not to intelligently process large amounts of data from large numbers of media to obtain only relevant information.

Even if the backup environment can be recreated, all the records may need to be examined. Those records may be for over thousand employees in a large company. Managing all this data is a nightmare even the environment can be recreated. For many companies, the amount of information can exceed a terabyte. Storing over a terabyte of information takes a lot of memory spaces and consumes valuable computer resources during the storing operation.

Beyond trying to manage the shear volume of data, other problems exist. Passwords of former employees may need to be replicated. Further, operating and backup applications become obsolete over time. In other instances, the information can only be backed up onto a specific machine that may no longer exist. Simply put, trying to extract any or all data from a large number backup tapes generated from different backup environments is difficult.

### SUMMARY OF THE INVENTION

A method and system can be used to read and obtain data from backup media regardless of the application used to generate the backup media. The method and system can read part of a tape to identify the application used to generate a backup tape and access information on where information is located on the tape based on an identifying signature. The method and system can be used to process large amounts of data from backup tapes without having to recreate the backup environment. Filters may be applied to determine which data is relevant and storing that information on a target sub-system that may have a different operating system compared to the computer from which the backup tape was generated. The method and system may be particularly useful for identifying and segregating evidence or for performing knowledge management functions at a company, potentially having over a thousand employees.

In one set of embodiments, a method of obtaining data from a backup medium can comprise reading data from the backup medium. The method can also comprise identifying an application used to generate the backup medium. The method can further comprise accessing information regarding a logical format for data on the backup medium. The method can still further comprise locating data on the backup medium based on the information regarding the logical format.

In another set of embodiments, a data processing system readable medium can have code embodied therein. The code can comprise instructions for carrying out the methods described herein.

In still other sets of embodiments, a system for retrieving information from backup media comprising a first backup medium, a second backup medium, a target sub-system, and a data extraction sub-system. The first backup medium may have been generated using a first backup application, and the second backup medium may have been generated using a second backup application. The data extraction sub-system may be capable of reading and understanding the information on the first and second backup media and storing at least a portion of the information onto the target sub-system.

The foregoing general description and the following detailed description are exemplary and explanatory only and are not restrictive of the invention, as defined in the appended claims.

### BRIEF DESCRIPTION OF THE DRAWINGS

The present invention is illustrated by way of example and not limitation in the accompanying figures.

FIG. 1 includes an illustration of a computing system to obtain data from a backup medium using a non-native environment in accordance with an embodiment of the present invention.

FIG. 2 includes an illustration of a data processing system storage medium including software code having instructions for carrying out the methods described herein.

FIG. 3 includes a process flow diagram for extracting data from a non-native environment in accordance with an embodiment of the present invention.

FIGS. 4-6 include illustrations of views of a hex editor that show identifying signatures of some backup systems in accordance with an embodiment of the present invention.

FIGS. 7-17 include illustrations of views of a hex editor that show information that can be obtained from a UNIX TAR backup system in accordance with an embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

The methods and systems described in more detail below can be used to circumvent the replication of an NE and extract data directly from backup media to a target storage system. The increased speed and efficiency of the Non-Native Environment (“NNE”) system and methods allow previously cost prohibitive data production jobs to be performed within reasonable cost and time parameters. By circumventing recreation of the NE, the methods and systems can eliminate the expense of hardware and time spent configuring software that is usually required in order to properly replicate a NE. By not relying on any specific replicated environment, the amount of parallel processing that can take place increases and jobs can be processed more efficiently in less time and achieve greater economies of scale.

Data extraction can now be performed in heterogeneous environments without having to recreate the backup application environment. A suite of software applications can be used to read tapes from any environment, any operating system, basically any host platforms and any backup system tape, more specifically, and process data from the backup media and restore it from the backup media without having to recreate the NE. The method and system described herein can obtain the data from a tape and interpret that data without reliance on the NE used to create that tape. It overcomes the problem that for some reason the data cannot be read by that original NE. The method and system can be used to get to the actual data itself and extract that data without any reference or reliance on the NE, whatever the software was that created it, or whatever software on which it was supposed to be read. The method and system allow data on nearly any storage medium to be read.

Among others, the method and system include the following advantages.

Recreation of the NE to restore backup data involves the procurement, setup and operation of backup/restoration software, servers upon which to load the software, and servers upon which to restore the data, all of which are expensive and time consuming. The method obviates the need for that operation and those costs, saving considerable time and money.

Commercial backup media require that the entire tape to be present and available for restoration. The method and system of data recovery technology described herein can potentially fill in gaps due to damaged tape or data and restore the rest.

Other aspects of the method and system can include:

Providing the capability of determining the best method for extracting data from a backup medium.

Linking a large number of media drives into a single computer (an “Octopus”) and processing all such media drives in parallel to save enormous amounts of processing time and storage costs because keyword searches.

Skipping to each file mark on a backup tape to see if that file is of a type that is of interest to be moved to the database on the target sub-system. If the file is of the wrong type, the processor skips to the next file mark. If the file is of the correct type, the processor will lift the data from the tape for processing.

Filtering data in whatever way is of interest (dates, file type, keyword searching, any metadata, etc.) as the data is read from the backup media and stored on the virtual media or other media at the target sub-system (e.g., all data can be read from the backup media and placed on the virtual or other media). If data meets the filtering criteria, it is left on the virtual or other media and if the data does not meet the filtering criteria, there may be substantially immediately deleted from the virtual or other media, and the process continues. The method and system can track the location of all original data as it is placed in a database at the target sub-system.

The requirement for organizations to comply with discovery requests for data contained on large numbers of archived backup media has become commonplace. Problems regarding the NE approach have been previously discussed. In order to successfully recover data in scenarios described with the NE approach, the method and system can be used to read and process data from a tape in the absence of the NE (in one embodiment a set of software utilities can read, interpret, and restore data from a number of disparate backup types). This is called “NNE” technology due to the fact that the software operates independently of the origin of the data. The NNE technology could easily be adapted for the purposes of large data productions. Moreover, eliminating any NE concerns made the process much easier as well as allowing for much more parallel processing.

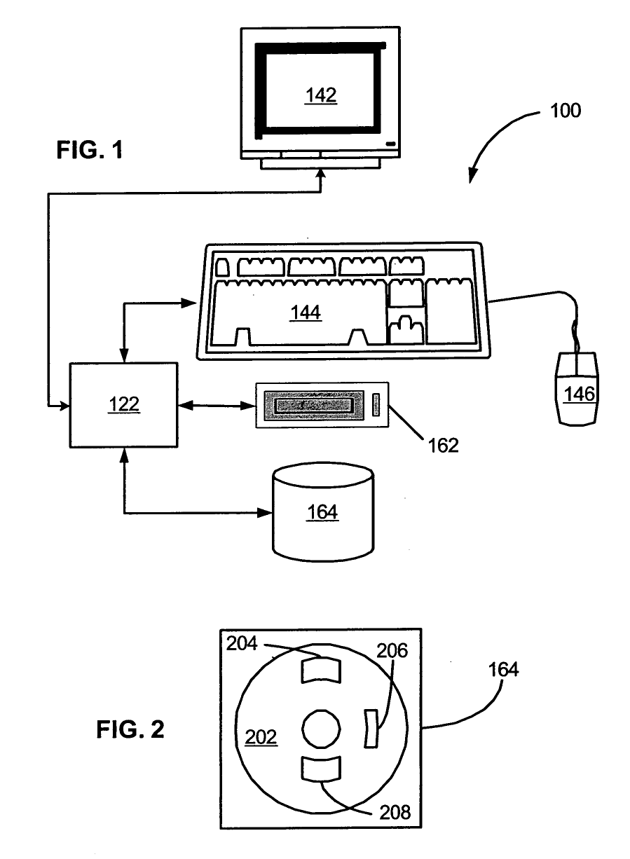

Before discussing embodiments of the present invention, an exemplary hardware architecture for using embodiments of the present invention is described. FIG. 1 illustrates such an exemplary hardware architecture and includes computer system 100 comprising central processing unit (“CPU”) 122. CPU 122 may comprise read-only memory (“ROM”), random access memory (“RAM”), or other types of volatile or non-volatile memory. CPU 122 is bi-directionally coupled to monitor 142, keyboard 144, backup media (tape) drive 162, and hard disk (“HD”) 164. An electronic pointing device, such as mouse 146, may be coupled to CPU 122 directly (not shown) or via keyboard 144. Other electronic pointing devices can include a trackball, stylus, and the like and may replace or be used in conjunction with mouse 146.

Note that FIG. 1 is a simplification of an exemplary hardware configuration. Computer system 100 may have more than one of the hardware components shown in FIG. 1. In addition, other peripheral devices (not shown) may be coupled to CPU 120 or other portion(s) of the computer system 100. Many other alternative hardware configurations are possible and known to skilled artisans. CPU 122 is an example of a data processing system. HD 162, ROM, RAM, and other memories can include media that can be read by the CPU 122. Therefore, each of these types of memories includes a data processing system readable medium.

Portions of the methods described herein may be implemented in suitable software code that may reside within HD 164, ROM, RAM, or other memory. The instructions in an embodiment of the present invention may be contained on HD 164 or other memory. FIG. 2 illustrates a combination of software code elements 204, 206, and 208 that are embodied within a data processing system readable medium 202 on HD 164. Alternatively, the instructions may be stored as software code elements on a magnetic tape, floppy diskette, optical storage device, or other appropriate data processing system readable medium or storage device.

In an illustrative embodiment of the invention, the computer-executable instructions may be lines of assembly code or compiled C, C⁺⁺, Java, or other language code. Other architectures may be used. A computer program or its software components with such code may be embodied in more than one data processing system readable medium in more than one computer.

Communications using computer system 100 in FIG. 1 can be accomplished using electronic, optical, radio-frequency, or other signals. For example, when a user is at computer system 100, CPU 122 may convert the signals to a human understandable form when sending a communication to the user and may convert input from the user to appropriate electronic, optical, radio-frequency, or other signals to be used by, other computer systems (not shown).

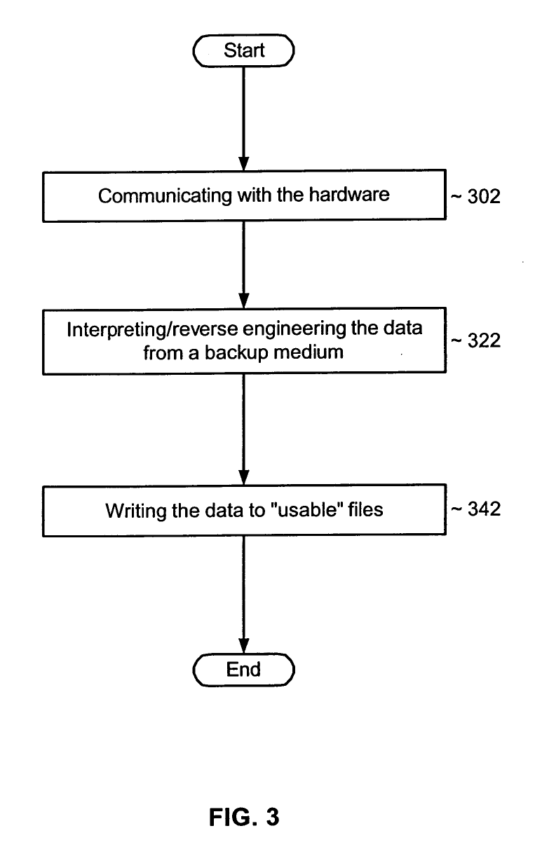

The method and system can involve taking backed up data (email, files, etc.) directly from the backup media without setting up the NE to restore the data for any one or more different purposes. In one embodiment, as illustrated in the flow chart in FIG. 3, the method can comprise communicating with the hardware (e.g., understand the stored data formats/hardware protocols (e.g., SCSI) in order to read the raw data) (block 302), interpreting/reverse engineering the data from a backup medium (e.g., extract the data directly from the backup media by understanding the system (e.g., UNIX TAR) and the protocols used in storing the data) (block 322), and writing the data to “usable” files (e.g., put the data onto the target sub-system in a manner consistent with the target sub-system protocols) (block 342).

Note that not all of the activities described in the process flow diagram are required, that an element within a specific activity may not be required, and that further activities may be performed in addition to those illustrated. Still further, the order in which each of the activities are listed are not necessarily the order in which they are performed. After reading this specification, skilled artisans will be capable of determining what activities can be used for their specific needs.

Initially, data may have been backed up onto backup media from any number of systems. Those systems may have different backup environments. After the data is on backup media, a need may exist to extract information from those backup media in response to a subpoena, an internal request for information, or for nearly any reason. As used in this specification, “tapes” refers to any backup media, whether it is actually tapes, CD ROM or similar long-term storage media. Initially, the information may reside on any number of tapes that may have been generated from different backup applications that operate on different platforms. The tapes may or may not be marked, and the markings are generally unreliable.

The first part of the method and system addresses communication with the hardware to read the data directly (block 302 in FIG. 3). Generally speaking, communication with hardware is done according to a specification for the hardware devices (e.g., the SCSI protocol for SCSI devices). In order to read the raw data from the tape, the system needs to understand the protocol that created it. Thus, the system needs to recognize the type of device (i.e., reading from a SCSI storage device) then understanding the protocol that allows reading the data directly from the device. Thus, the communication with the hardware and the reading the raw data directly requires identifying what type of device is being accessed (e.g., a SCSI device, a fibre channel device, etc.), and then based on the protocols for that particular device (e.g., SCSI, iSCSI, fibre channel, etc.), developing a software program that will go in and read the data directly from that device.

In order to develop the program for a particular protocol, a programmer would need to review protocol and understand to a certain degree the protocol in order to write a program that will extract the data from that type of protocol device directly. While there may be nuances about each different protocol (e.g., how you do it for a SCSI device may not be the same as how you it for a fibre channel device, etc), skilled artisans understand the protocols, and therefore, the process itself is re-creatable.

In order to do get access to the information on the tape, in one embodiment, the method can comprise communicating with the hardware as shown in block 302 of FIG. 3. A backup tape may be inserted into tape drive 162, which reads the first portion of the tape. The information used to identify the backup application can be located in the first portion of the tape. In another embodiment the information may be at a different location(s), thus other portion(s) of the tape may be read. In still another embodiment, the entire tape may be read before starting to interpret or reverse engineer data from the tape. These other embodiments may be useful if the identifying signature would lie at an unconventional location (near the end of the tape or buried inbetween).

The method and system can then interpret/reverse engineer the raw data (block 322 in FIG. 3). After raw data from the first part of the tape is obtained, the method can further comprise interpreting/reverse engineering the raw data to determining the backup environment (i.e., hardware, backup software application, etc.). In the case of simply an NNE data extraction, the data will be interpreted before it is put into a database at a target sub-system. Backup tapes originate from a huge variety of different operating systems and backup systems. Thus, a huge disparity can occur regarding data for any given piece of backup media and what system might have put it there. So on any particular tape, there may be any number of types of data, and there may be any number of sources of that data, all of which can be taken into account.

There are tens, if not hundreds, of different backup vendors and backup applications. Knowledge of the different backup environments is applied to raw data obtained from the backup tape. The raw data and patterns within the raw data can be examined to determine the identity of the backup system. The identification can be based on a sequence of data, a byte signature, or the like.

The backup environment may be independent of the operating system of the computer from which the data on the tape was obtained. Thus, the first reverse engineering act for interpretation is to identify the application used to generate or vendor by which the backup tape (e.g., by what software). For example, Backup Exec™, ARCserve™ or UNIX TAR are just some examples of backup systems that may be used in storing data on a backup tape. Thus, the method and system can be used to identify that the tape was created using, for example, Backup Exec™ versus a UNIX TAR. This can be done using identifying signatures in the raw data. Identifying signature is to be construed broadly to mean any information, whether a single character, combination of character or other indicia (e.g., electronic signal(s) when reading a tape that can be used, at least in part to identify the backup application or environment. A software application can be used to convert the information to a form that is more user friendly. In one non-limiting embodiment, a hex editor may be used.

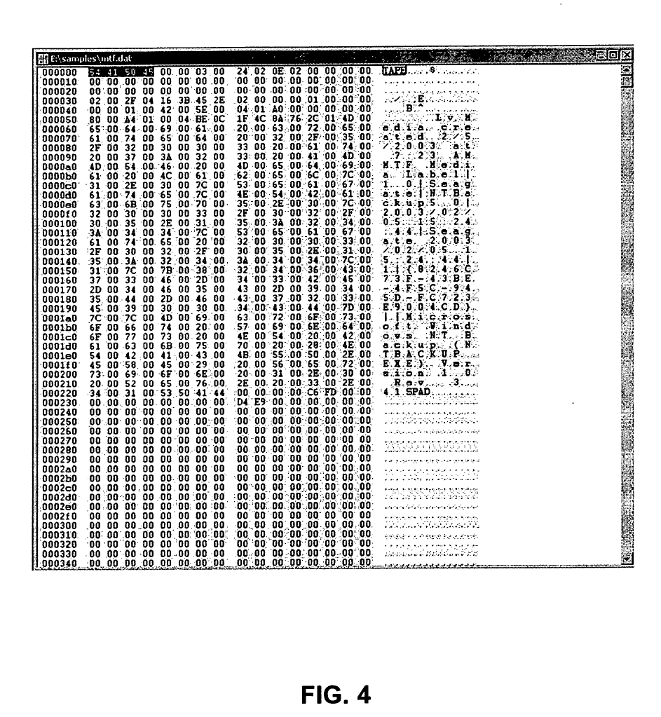

In one non-limiting example, the software can search for specific identifiers in the data to identify a tape as being created using Backup Exec™ (also known as “NT Backup”). For Backup Exec™, the first thing the software can look at the first block of the tape for a media label. The first four bytes of that media label (i.e., the first four bytes that you read off the tape) is a signature, which in ASCII, is the word “TAPE” as illustrated in FIG. 4. “TAPE” is the indicator that the backup tape was generated using Backup Exec™. In one embodiment, the system can include some identification software that can include an algorithm that searches for the ASCII word “TAPE” to identify Backup Exec™ tapes.

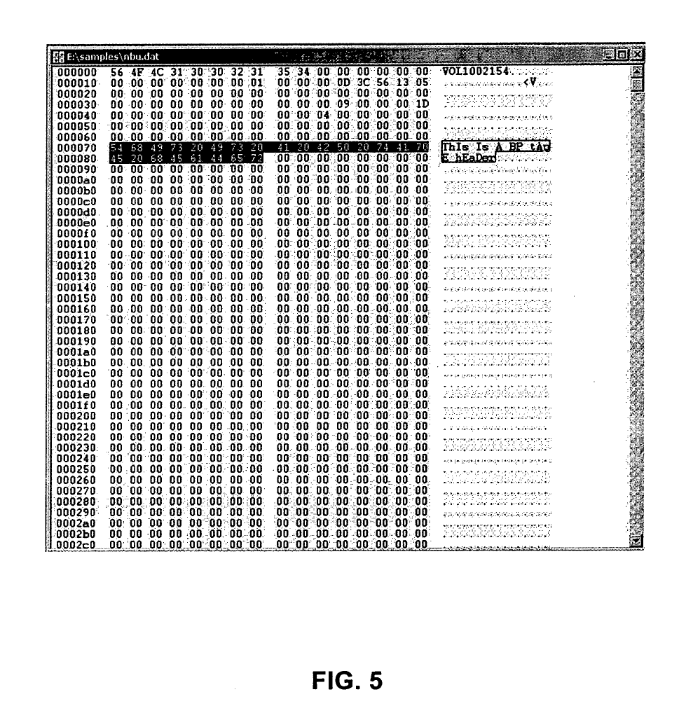

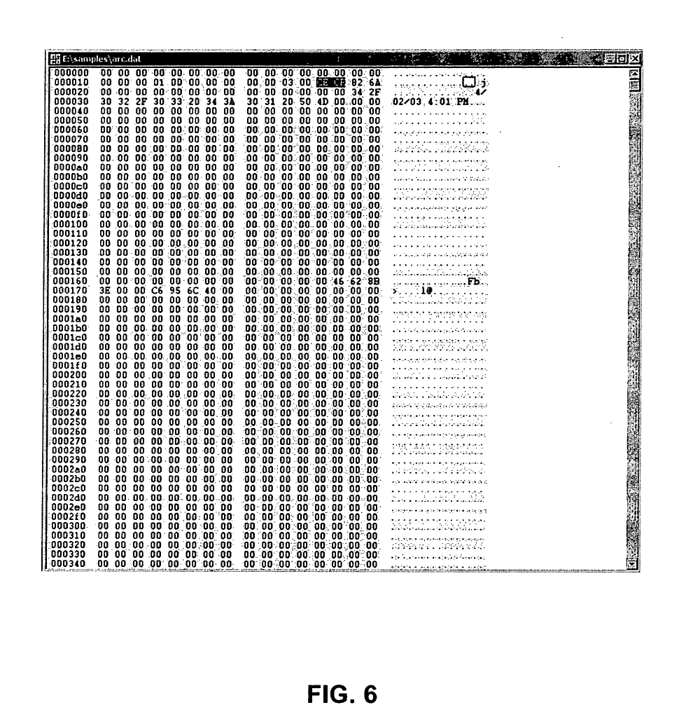

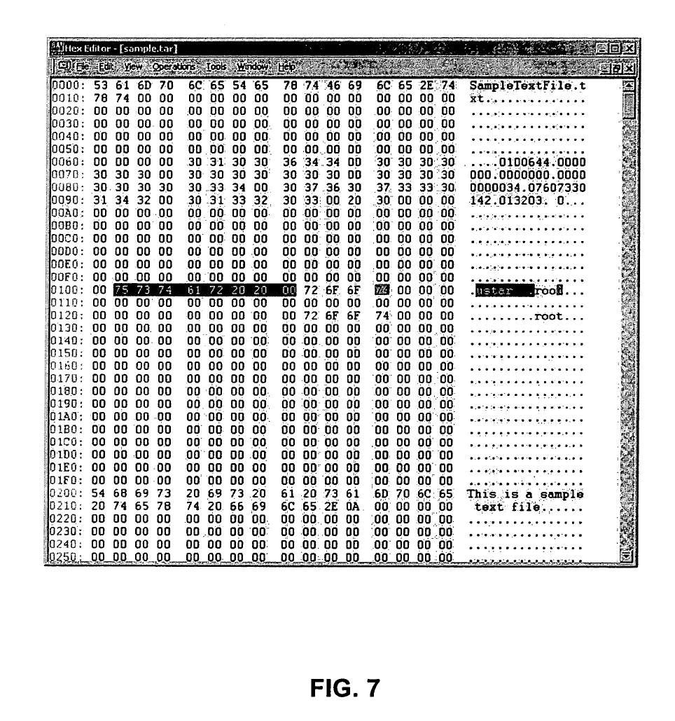

If the backup tape was not generated using Backup Exec™, other algorithms based on signature identifiers of other backup applications may be used. With Veritas' NetBackup™ product, there is an easily identifiable string at offset 0x70 (112 bytes into the tape), “ThIs Is A BP tApE hEaDer” as illustrated in FIG. 5. Computer Associates' ARCserve™ application has a signature of “CE CE” starting at offset 0x1C (29 bytes into the tape) as illustrated in FIG. 6. UNIX TAR backup application includes “ustar” (FIG. 7). An example with the UNIX TAR backup application is described in more detail later in this specification. After reading this specification, skilled artisans will appreciate that other backup applications will have other signature identifiers.

After a system/vendor of the backup environment is identified (and therefore a logical format for the data is known), a focus shifts to becoming a matter of knowing how that vendor or that logical format manipulates the data. In order to take an arbitrary on-tape file system and extract the files, there is some information that is virtually necessary, and other information that is typically helpful. Information that is virtually necessary includes:

How to find a file;

File name; and

At least two of the following:

File size;

Start of file data; and

End of file data or end of file marker.

Information that is typically helpful includes:

File attributes;

Create, access, modified dates, or combinations thereof;

File type; and

Owner/access information.

These examples are meant to illustrate and not limit the present invention.

Each particular file may have information stored, such as its name, any attributes that it has (such as, file creation date, the file's last modification date, the file's last access date, etc.). This information is generally referred to as the file's metadata. Both the metadata and the actual (“content”) data of the file are stored by the backup application. The reverse engineering process becomes identifying where the metadata resides in relation to the content data of the same file. This information may be stored in HD 164 as a file or a table within a database. After the identity for the vendor/backup system used to create the backup tape is known, the method and system can access the logical format information used by that particular vendor/backup system to determine the location and type of information available in the file. Location is to be construed broadly and is used to designate one or more points in a tape where information may be found. Note that the same type of information (e.g., content of a file) may or may not lie at contiguous addresses on a tape. Therefore, location may include starting, ending, or intermediate address(es) for the information, potentially starting, ending, or intermediate address(es) for discontinuous portions of the information, or any combination thereof.

After the locations of the metadata and content data for a file have been determined, the interpretation step is complete. Thus, the reverse engineering process is essentially performed after the logical format is identified. The method and system use that logical format for a particular set of raw data. For example, one piece of metadata exists at X location and the file content data starts at Y location.

When working with data other than files, then instead of searching for file-specific characteristics, such as file metadata and file stream data, a different set of characteristics can be used. The method is still basically the same: search for an identifying signature and determine the logical format for the data stream that is specific to the vendor/backup system used to generate the backup tape. After the logical format is determined, the method and system can be used to search for whatever information is desired.

Many different tasks may be performed based on the objective of the use. Applications, such as parallel processing, searching, and filtering, may be performed before data is written to a target sub-system. These tasks can increase the speed and efficiency is performing the application to obtain the data more quickly than using conventional systems and techniques. Note the many other applications with different objective can be performed. The descriptions regarding the applications and tasks performed by the method and system are meant to illustrate and not limit the present invention.

The method and system can write the data into “useable” files (block 344 in FIG. 3). The turning of the raw data into understandable data involves understanding another set of protocols on the target sub-system. Non-limiting exemplary target sub-systems can include storage disks, hard drives, conventional backup tapes, flash memory, and the like. The target sub-system is the system on which the extracted data is to be stored. The protocol used for storing the files onto a Windows NT server is different than the protocol used for storing the files onto a UNIX server. Depending on the target, the set of Application Program Interfaces (“APIs”) for that target sub-system should be understood in order to recreate that data on that target sub-system. For example, on a Windows 2000™ system, the method and system used to extract the data needs to know how to write the extracted data to a file onto the target sub-system and manipulate the metadata like set the creation dates to the appropriate date, set any other file-specific attributes.

The manipulation can be performed by the APIs to which the method and system are interacting on that target sub-system. Note that this operation is similar to activities previously described but done in reverse. After the identity of the target sub-system (e.g., Windows, UNIX, Linux, Macintosh, etc.) is known, the protocol/APIs of that target sub-system for storing files can be looked up from a file with the information or a table within a database. The method and system ensure that the file content data and metadata is translated and stored on the target sub-system at the proper location, so that the target sub-system can read the metadata and raw file data.

Attention is now directed to some specific applications for using the method and system. The applications illustrate how the method and system may be used to leverage advantages over conventional systems. The method and system are particularly well suited for handling a number of tasks that are described below. A few non-limiting applications are described below.

The method and system are good at handling a large amount of information by taking advantage of parallel processing. When it comes time for large evidence processing cases, if an NE approach is used, the NE system is limited to a singular type of restore methodology (i.e., restoring one server at a time on one piece of hardware). But since the method and system described herein do not depend on the NE, the system can run many of these processes in parallel (i.e., a single data processing system processing multiple tapes simultaneously). When processing two tapes in parallel, one tape may have information output to a first directory, and a second tape may have information output to a second directory.

The information retrieved is not bound to a specific server. By using the logical format of the target sub-system, the method and system can bind the information in a format for specific targets. Without this method and system, the NE is bound to the system to which information is being restored. In other words, the information must be restored before any manipulation of data or files can be performed.

The method and system herein can be used to discover the data without using the NE, and therefore, the method and system are not limited to the specific hardware setup of the computer from which the data on the tape was obtained. The conventional attempts at addressing the problems previously described either create multiple instances of the same environment or else process tapes sequentially. By using the method and system described herein, the same method and system can be used to extract information from tapes regardless of backup environment because the backup environment does not need to be recreated.

Another application can be used to search backup tapes for specific file types. The NNE technology can be used skip to each file marked on a backup tape to determine if it is of a type that is of interest. When backup tapes are made, most backup systems initially use a session for the server from which the data originated (e.g., the volume originated and sometimes clues as to what type of data it is). This information can become important in the case where extraction is going after a single type of file. So, at the end of the session, the method and system can find this indicator that the tape is a backup of a Microsoft Exchange Server, and at that point (because it is an email server) the data is extracted. At the next session the same analysis may be performed, and if it is not a backup of an email server, the data is not extracted or stored. An understanding of session types allows the ability to extract particular types of data, for example email, instead of extracting all of the data. Thus, the method and system has the ability to get a subset of the data rather than all of the data.

Searches may be performed on the metadata from the header portion of the file or directory may be sufficient. Optionally, requests can search on the content portion of the file or directory.

In yet another application, the method and system can be used to filter data on the fly as it is read from the backup tape. In addition to looking at session or section types, the method and system can also look at what is in those sessions. For example, if the extraction is targeting Microsoft Word documents but not the Excel Spreadsheets. Within a particular session, as the data is read the information about the file name can be reviewed for a particular extension (such as “.doc”) and only those extension types are actually extracted. For example, each file that is found that ends with “.doc” is sent to the target sub-system and those that do not end with “.doc” are not. In another example, only JPEG images files and not GIF image files are to be obtained. A search could be performed on “.jpg” to locate the JPEG files.

There are other ways to filter in addition to or as an alternative to the filename extension. Date is often used (e.g., files that were created between a beginning and ending date). The method and system can analyze each file's creation date and extract only those that meet the date criteria identified. Multiple filters may also be used.

The ability to filter data can be useful for evidence and knowledge management purposes. For example, a discovery request may only be concerned with documents before or after a specific date or within a range of dates. Another part of the discovery request may indicate that documents are related to a design of a product is relevant. For this portion of a discover request, the group corresponding to a design team may be relevant, whereas the group corresponding to human resources would be irrelevant. Knowledge management may be useful regarding prior work done by others or others that have experienced the same or a similar problem currently being encountered.

The method and system can be selective regarding actions to be performed after obtaining the data. If only a listing is desired, then as a storage saving strategy, no content may be stored to save on time and money. However, in some instances, all of the metadata and content is extracted and stored onto hard disks or other persistent media as is described in more detail below. The method and system are highly flexible and allows users more options to obtain information in a quicker and more efficient manner.

### EXAMPLE

The example below illustrates information that can be obtained from a backup tape generated from a UNIX TAR backup environment. The tape can be identified as UNIX TAR by the value “ustar” starting at offset 0x101 (257 bytes from the beginning) in FIG. 7. The table below illustrates information that can be obtained just by reading some of the tape near the beginning of a file. Information from the table below may be part of a database table or file that can be used in conjunction with a software application to locate information within the file. Please note the example merely illustrates and does not limit the present invention. Other backup systems will have similar information within a database table or file that can be used in location information from a backup tape.

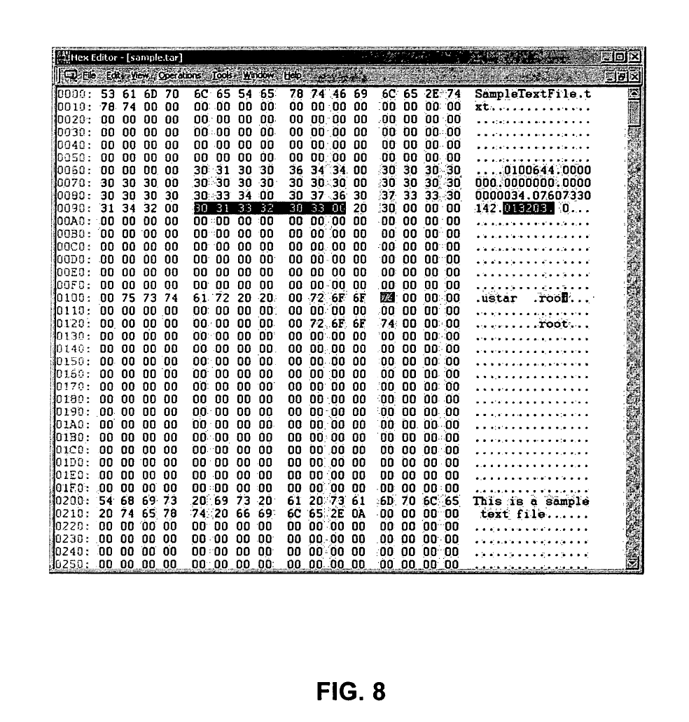

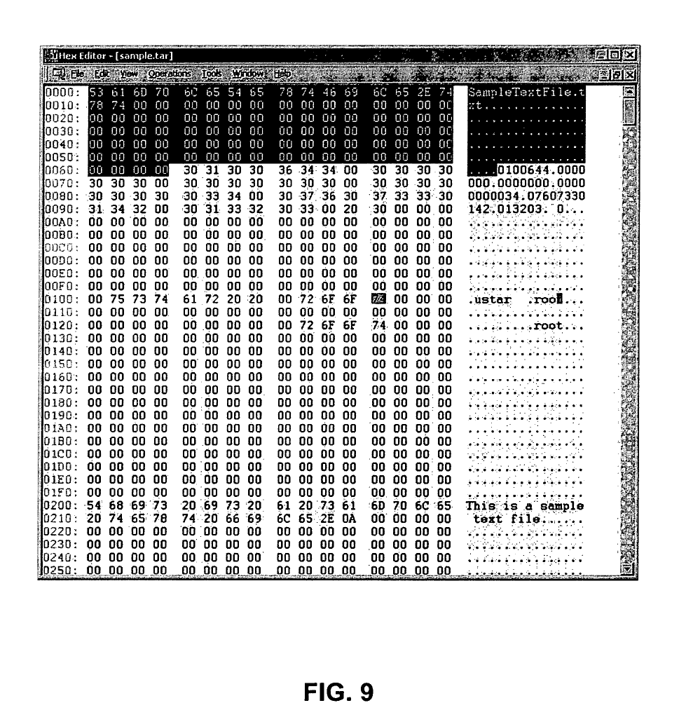

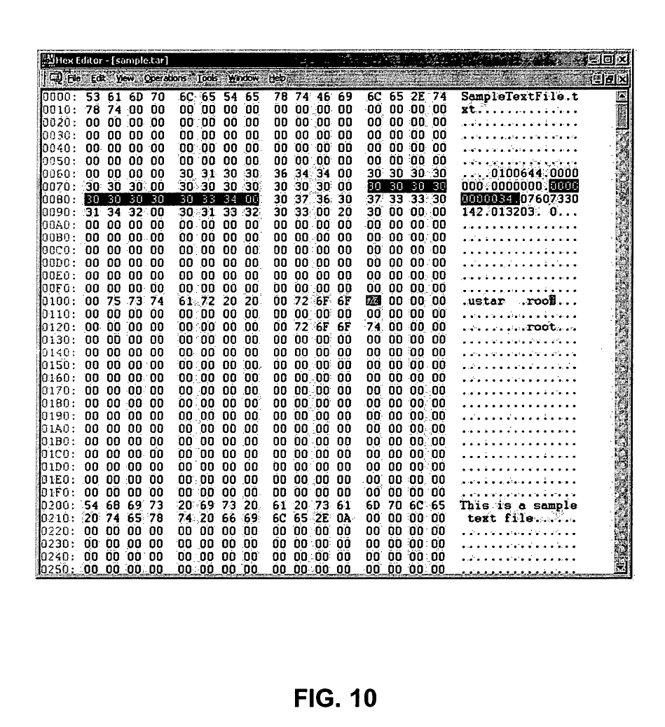

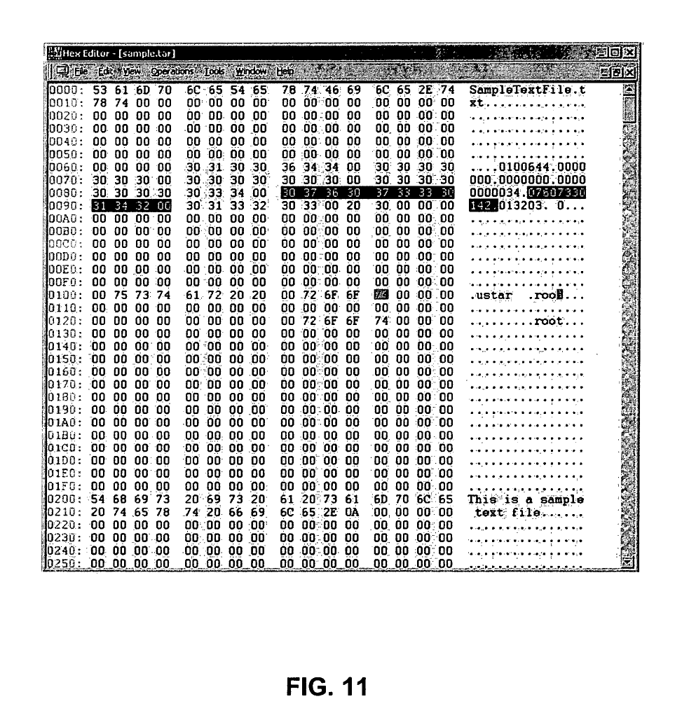

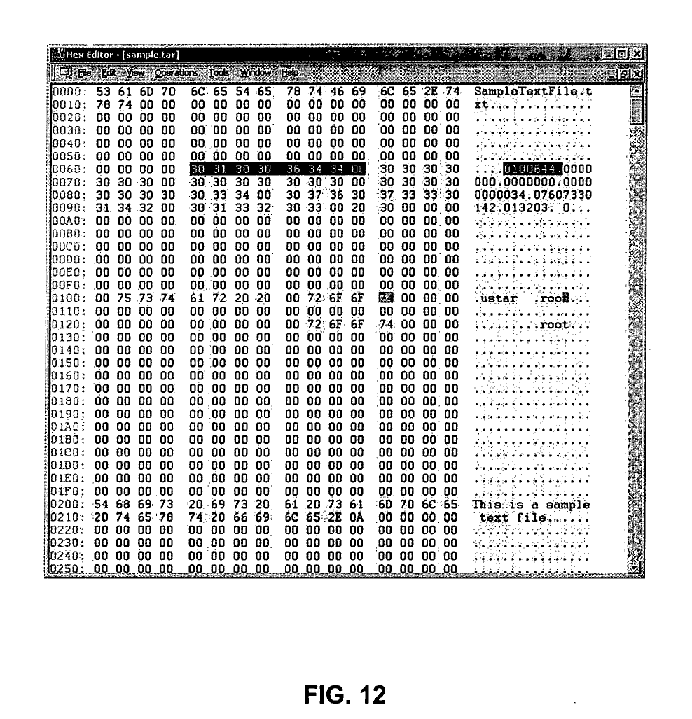

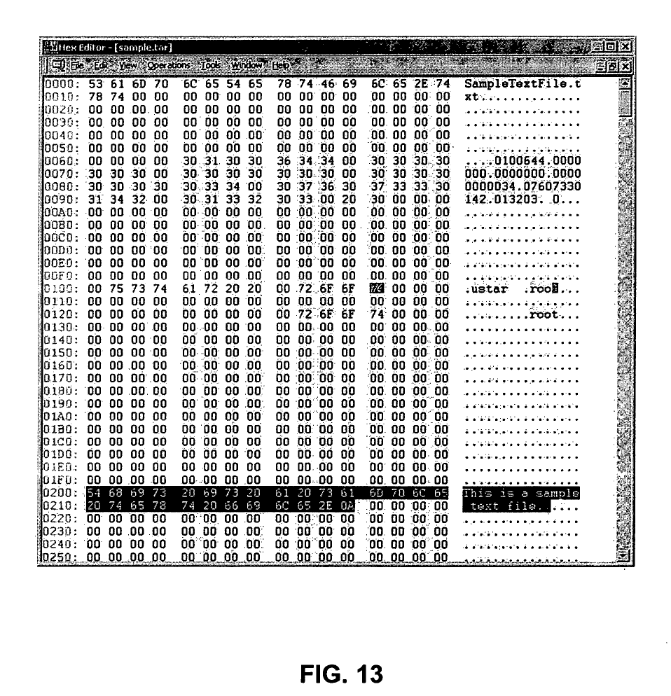

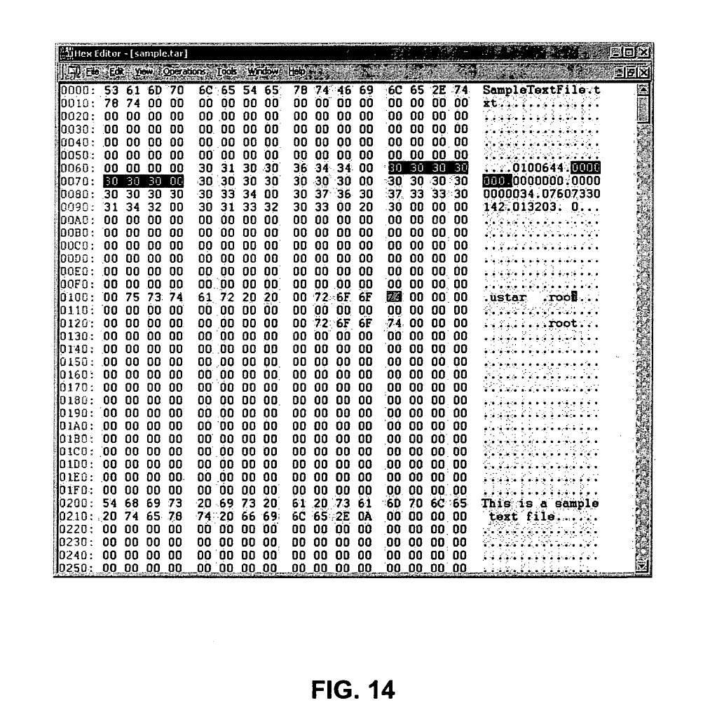

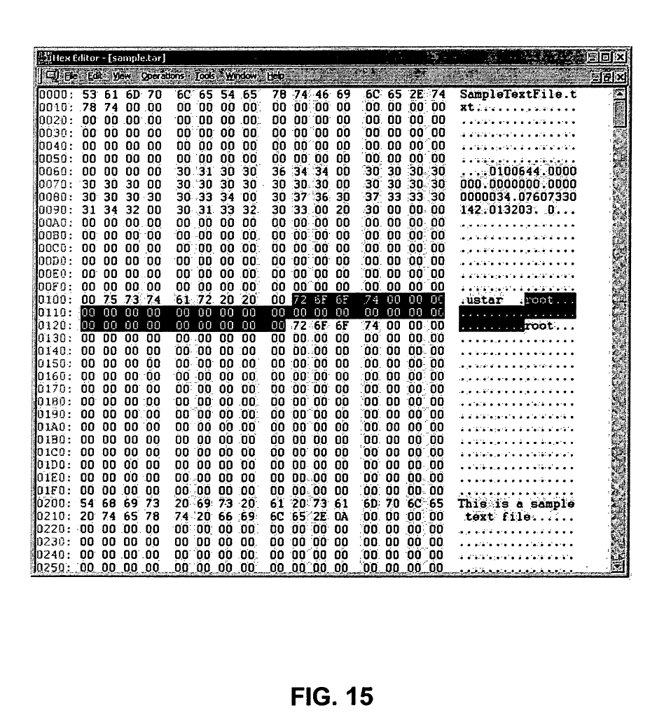

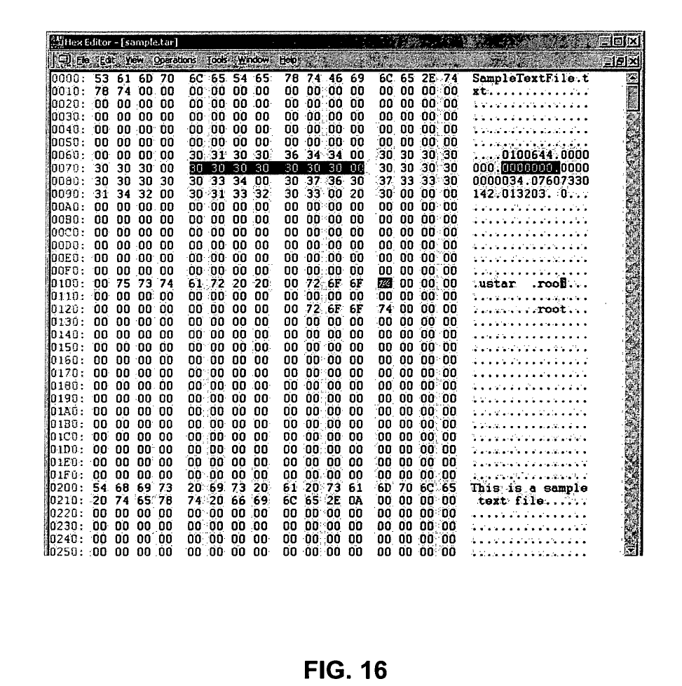

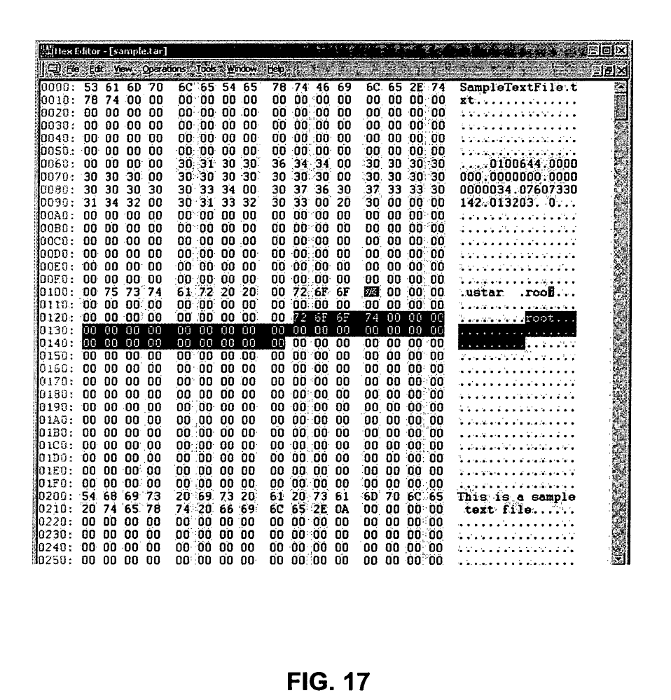

In the table below, the offsets are the locations of the information as expressed in a hexadecimal format. The bytes column expresses the location as a base-10 number of bytes where the information is located. The description gives a description of the information found starting at that location. The value shows the value of the information for this specific example. The “FIG.” column refers to the figure in which the information is highlighted. Please note that the information in FIGS. 7-15 is substantially the same; however, different portions of the information are highlighted for convenience. In the figures, the left-hand portion represents the offset value, the center portion includes hexadecimal values of the information, and the right-hand portion represents ASCII characters corresponding to the hexadecimal values.

TABLE

| Offset | Bytes | Description | Value | FIG. |
|---|---|---|---|---|
| 0x101 | 257 | Identifying | ustar | 7 |
| | | signature | | |
| 0x94 | 148 | Checksum for file | 13203 | 8 |
| | | header | | |
| 0x0 | 0 | File name | SampleTextFile.txt | 9 |
| 0x7C | 124 | File size | 34 | 10 |
| 0x88 | 136 | File last | 767330142 | 11 |
| | | modification date | | |
| 0x64 | 100 | File permissions | 100644 | 12 |
| 0x200 | 512 | File content | This is a sample | 13 |
| | | | text file | |
| 0x6C | 108 | Owner identifier | 0 | 14 |
| 0x109 | 265 | Owner name | root | 15 |
| 0x74 | 116 | Group identifier | 0 | 16 |
| 0xl29 | 297 | Group name | root | 17 |

A few notes regarding the numeric values in the table are made to clarify their understanding. Numeric values in the “Value” column are base-8 numbers. Referring to the file size, 34 in base-8 corresponds to 28 in base-10. Therefore, the file size is 28 bytes long. The last modification date has the base-8 value for the number of seconds that have elapsed since Jan. 1, 1970. Therefore, the value 7607330142 is equivalent to Jan. 9, 2003, at 5:34:23 pm, which is when SampleTextFile.txt was last modified.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited to only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” are employed to describe elements and components of the invention. This is done merely for convenience and to give a general sense of the invention. This description should be read to include one or at least one and the singular also includes the plural unless it is clear that it is meant otherwise.

What is claimed is:

1. A method of obtaining data from a first backup medium comprising:
reading data from the first backup medium;
identifying an application used to generate the first backup medium;
accessing information regarding a logical format for data on the first backup medium; and
locating data on the first backup medium based on the information regarding the logical format.

2. The method of claim 1, wherein identifying comprises searching for an identifying signature used by the application.

3. The method of claim 1, wherein the information regarding the logical format includes a location where a specific type of information within the first backup medium is found.

4. The method of claim 3, wherein the information regarding the logical format includes a location on the first backup medium for: a checksum for a file header, a file name, a file size, a marker used to denote an end of file, a file last modification date, a file creation date, a file permission, start of a file content, an owner identifier, an owner name, a group identifier, a group name, or any combination thereof.

5. The method of claim 1, further comprising, in response to locating, extracting a portion of the data from the first backup medium.

6. The method of claim 5, further comprising filtering the portion of the data to obtain at least a part of the portion of the data.

7. The method of claim 6, wherein filtering is based on a criterion including a file name extension, a date that a file was created or last modified, an owner, or a group.

8. The method of claim 6, further comprising storing the at least a part of the portion of the data on a target sub-system.

9. The method of claim 1, wherein:
the method is performed on a second backup medium;
the second backup medium was generated using a different application compared to the application that generated the first backup medium; and
during at least one point in time, the method is performed on the first and second backup media on the same system simultaneously using a single data processing system.

10. The method of claim 1, wherein reading data from the first backup medium comprises reading data from a portion of the first backup medium.

11. The method of claim 1, wherein accessing information is performed in response to identifying the application.

12. A data processing system readable medium having code embodied therein, the code comprising:
an instruction for reading data from the first backup medium;
an instruction for identifying an application used to generate the first backup medium;
an instruction for accessing information regarding a logical format for data on the first backup medium; and
an instruction for locating data on the first backup medium based on the information regarding the logical format.

13. The data processing system readable medium of claim 12, wherein the instruction for identifying comprises an instruction for searching for an identifying signature used by the application.

14. The data processing system readable medium of claim 12, wherein the information regarding the logical format includes a location where a specific type of information within the first backup medium is found.

15. The data processing system readable medium of claim 14, wherein the information regarding the logical format includes a location on the first backup medium for: a checksum for a file header, a file name, a file size, a marker used to denote an end of file, a file last modification date, a file creation date, a file permission, start of a file content, an owner identifier, an owner name, a group identifier, a group name, or any combination thereof.

16. The data processing system readable medium of claim 12, further comprising, in response to locating, an instruction for extracting a portion of the data from the first backup medium.

17. The data processing system readable medium of claim 16, further comprising an instruction for filtering the portion of the data to obtain at least a part of the portion of the data.

18. The data processing system readable medium of claim 17, wherein the instruction for filtering is based on a criterion including a file name extension, a date that a file was created or last modified, an owner, or a group.

19. The data processing system readable medium of claim 17, further comprising an instruction for storing the at least a part of the portion of the data on a target sub-system.

20. The data processing system readable medium of claim 12, wherein:
the data processing system readable medium can be used on a second backup medium;
the second backup medium was generated using a different application compared to the application that generated the first backup medium; and
during at least one point in time, a single data processing system can execute the instructions of the data processing system readable medium for the first and second backup media simultaneously.

21. The data processing system readable medium of claim 12, wherein the instruction for reading data from the first backup medium comprises an instruction reading data from a portion of the first backup medium.

22. The data processing system readable medium of claim 12, wherein the instruction for accessing information is performed in response to identifying the application.

23. A system for retrieving information from backup media comprising:
a first backup medium, wherein the first backup medium was generated using a first backup application;
a second backup medium, wherein the second backup medium was generated using a second backup application;
a target sub-system; and
a data extraction sub-system capable of reading and understanding the information on the first and second backup media and storing at least a portion of the information onto the target sub-system.

24. The system of claim 23, wherein the first and second backup applications use different operating systems.

25. The system of claim 23, wherein the data extraction sub-system comprises information regarding the logical format for information on the first and second backup media and the target sub-system.
